(19) United States
(12) Patent Application Publication
(10) Pub. No.: US 2021/0402642 A1
(43) Pub. Date: Dec. 30, 2021

(54) Work Implement

(71) Applicant: Andreas Stihl AG & Co. KG, Waiblingen (DE)

(72) Inventor: Benedikt Posner, Stuttgart (DE)

(21) Appl. No.: 17/358,030

(22) Filed: Jun. 25, 2021

(30) Foreign Application Priority Data
Jun. 30, 2020 (EP) 20 183 204.5

(51) Int. Cl. B27B 17/00

(52) U.S. Cl. CPC B27B 17/0033; A01G 23/091

(57) ABSTRACT

A work implement is provided with a tool that has an opening. A housing part is provided and a stud bolt is screwed into the housing part. The stud bolt fastens the tool to the housing part. The stud bolt projects axially away from the housing part and projects at least partially into the opening of the tool. A transmission element is provided for transmitting transverse forces, acting transversely to the axial direction, from the tool to the stud bolt. The transmission element is a first element made at least partially of a first material with modulus of elasticity of 1 GPa to 80 GPa, or the transmission element is a second element with a spring element at least partially made of a second material with modulus of elasticity of larger than 80 GPa and with a free space for a spring travel of the spring element.

### BACKGROUND OF THE INVENTION

The invention relates to a work implement comprising a tool, a housing part, and a stud bolt screwed into the housing part for attachment of the tool to the housing part, wherein the stud bolt projects out of the housing part along an axial direction, wherein the tool comprises an opening, wherein the stud bolt projects at least partially into the opening, wherein the work implement comprises a transmission element for transmitting transverse forces, acting transversely to the axial direction, from the tool to the stud bolt.

GB 2481037 A discloses a work implement with a stud bolt. The work implement has attached thereto a guide bar with saw chain as a tool. Between the guide bar and the stud bolt, a sleeve of silicone is arranged. The stud bolt is fastened in a housing part of the work implement. In operation of the work implement, forces are transmitted from the guide bar to the stud bolt. These forces can damage the connection between the stud bolt and the housing part and, in an extreme case, can even cause the stud bolt to become detached from the housing part. For absorbing these forces, GB 2481037 A employs the sleeve of silicone. The sleeve quickly wears in operation so that the damping action of the sleeve is weakened or completely destroyed. A continued operation of the work implement can then quickly destabilize the connection between stud bolt and housing part.

It is an object of the invention to further develop a work implement of the aforementioned kind such that a wear-resistant and safe operation of the work implement is possible.

### SUMMARY OF THE INVENTION

In accordance with the invention, this is achieved for a work implement of the aforementioned kind in that the transmission element is embodied as a first element and the first element is at least partially comprised of a first material that comprises a modulus of elasticity of 1 GPa to 80 GPa, or in that the transmission element is embodied as a second element and the second element comprises a spring element, comprised at least partially of a second material with a modulus of elasticity of larger than 80 GPa, and further comprises a free space for a spring travel of the spring element.

According to the invention, it is provided that the transmission element is embodied as a first element and that the first element is comprised at least partially of a first material that has a modulus of elasticity of 1 GPa (1×10⁹ N/m²) to 80 GPa (80×10⁹ N/m²), or that the transmission element is embodied as a second element and that the second element comprises a spring element and a free space for a spring travel of the spring element, wherein the spring element is comprised at least partially of a second material comprising a modulus of elasticity of larger than 80 GPa.

It has been found that even materials with a higher modulus of elasticity than silicone are sufficient, or are even better suited, in order to damp forces that are transmitted from the tool to the stud bolt. Since the first element is comprised at least partially of a first material that comprises a modulus of elasticity of 1 GPa to 80 GPa, the first element wears only by a very small amount and dampens at the same time in a satisfactory manner the transverse forces which are transmitted from the tool to the stud bolt. In this way, the work implement can be operated safely and in a wear-resistant way. Damage of the connection between the stud bolt and the housing part by the transverse forces is effectively prevented in this way. A safe and wear-resistant operation of the work implement is possible in this way. Forces can be transmitted in this way even at high transmission frequency with minimal spring travel.

Since the second element comprises a spring element comprised at least partially of a second material with a modulus of elasticity of larger than 80 GPa and further comprises a free space for a spring travel of the spring element, the second element can be produced of a wear-resistant material. In this way, the second element, in particular the spring element, wears only by a very minimal amount and dampens at the same time sufficiently the transverse forces that are transmitted from the tool to the stud bolt. In this way, the work implement can be operated safely and in a wear-resistant way. Since the second element is comprised at least partially of a second material that comprises a modulus of elasticity of larger than 80 GPa, the second element can be designed to be particularly wear-resistant and exhibit a long service life.

The two variants according to the invention have in common the technical effect that the respective transmission elements achieve a good damping action with minimal wear. The good wear behavior is achieved by materials with a modulus of elasticity of at least 1 GPa. Up to 80 GPa (80 GPa included), the damping action of the materials themselves is sufficient. Above 80 GPa, the transmission element must additionally comprise the spring element and the free space for the spring travel of the spring element in order to achieve a satisfactory damping action. The second element is advantageously designed such that it acts at least partially in a springy fashion due to its shape for the transfer of the transverse forces. The second element is therefore also referred to as a shape spring.

In an advantageous further embodiment of the invention, it is provided that the transmission element in respect to the axial direction extends completely circumferentially around the stud bolt.

Advantageously, the transmission element is arranged between the opening and the stud bolt. In particular, the transmission element is arranged with clearance on the stud bolt. This facilitates mounting and demounting of the tool.

Expediently, the transmission element is fastened to the tool. In this way, an exchange of the tool is possible without there being the risk of losing the transmission element.

In an advantageous embodiment of the invention, it is provided that the opening comprises a rim and that the transmission element is fixed at the rim of the opening of the tool. In this way, the transmission element is captively connected to the tool. The work implement is comprised of a reduced number of individual components and can therefore be mounted and demounted easily.

In an advantageous variant of the invention, the transmission element is fastened to the stud bolt. In this way, it can be prevented that the transmission element is lost when exchanging the tool. In particular, the transmission element is captively fastened at the stud bolt.

In a particular embodiment of the invention, the transmission element is exchangeably held at the stud bolt. In this way, an adaptation of the stiffness of the system comprised of housing part, stud bolt, transmission element, and tool is possible in a simple manner. For example, when using a different tool, the transmission element can be adjusted to the changed situation by exchange of the transmission element for another transmission element with a different modulus of elasticity. Should the transmission element be worn after an extended period of use, an exchange of the worn transmission element for a new transmission element is possible in a simple manner due to the exchangeability.

Advantageously, the transmission element is a sleeve. Expediently, the sleeve comprises substantially the shape of a hollow cylinder. A substantially hollow cylindrical sleeve can also be a slotted sleeve.

Expediently, the first element consists completely of the first material. In this way, a simple manufacture of the first element is possible. Advantageously, the first material is plastic material. In particular, the first material is no elastomer. It can also be provided that the first material is a light metal. In particular, the first material can be aluminum. The first material can also be an aluminum alloy.

Advantageously, the second element consists completely of the second material.

In particular, the spring element of the second element is arranged between the free space of the second element and the stud bolt.

Expediently, a free space width of the free space of the second element that is measured radially in relation to the longitudinal axis of the stud bolt and perpendicularly to a longitudinal center axis of the tool, amounts to at least 10%, in particular at least 20%, of a spring width of the spring element that is measured radially in relation to the longitudinal axis of the stud bolt and perpendicularly to the longitudinal center axis of the tool. In this way, a shape spring can be formed. Despite the large modulus of elasticity of the spring element of larger than 80 GPa, the second element can be designed such that the damping action of the second element is sufficient.

In particular, the housing part is at least partially made of light metal, in particular of aluminum. In this way, the work implement is lightweight and easy to handle. It can also be provided that the housing part is comprised of an aluminum alloy or a magnesium alloy.

In particular, the tool is free of rotational symmetry with regard to the longitudinal axis of the stud bolt. The tool comprises advantageously no rotational symmetry in relation to the longitudinal axis of the stud bolt. In particular, at least one part of the tool is immobile relative to the housing part in operation of the work implement.

### BRIEF DESCRIPTION OF THE DRAWING

Embodiments of the invention will be explained in the following with the aid of the drawings.

FIG. 1 is a schematic perspective illustration of a work implement with a stud bolt and a guide bar.

FIG. 2 is an exploded view of parts of the work implement of FIG. 1.

FIG. 3 is an exploded view of parts of a work implement.

FIG. 4 is a section view of the work implement of FIG. 3 wherein the section plane contains a longitudinal axis of a stud bolt and a longitudinal center axis of a guide bar.

FIG. 5 is an exploded view of parts of an alternative embodiment of a work implement.

FIG. 6 is a section view of the work implement of FIG. 5 wherein the section plane contains a longitudinal axis of a stud bolt and a longitudinal center axis of a guide bar.

FIG. 7 is a side view of a guide bar and stud bolts showing an embodiment of a transmission element.

FIG. 8 is a section view of a guide bar and stud bolts showing another embodiment of a transmission element.

FIG. 9 is a side view of a guide bar and stud bolts in yet another embodiment of a transmission element.

FIG. 10 is a schematic illustration of a second element as transmission element embodied as a wire mesh structure.

### DESCRIPTION OF THE PREFERRED EMBODIMENTS

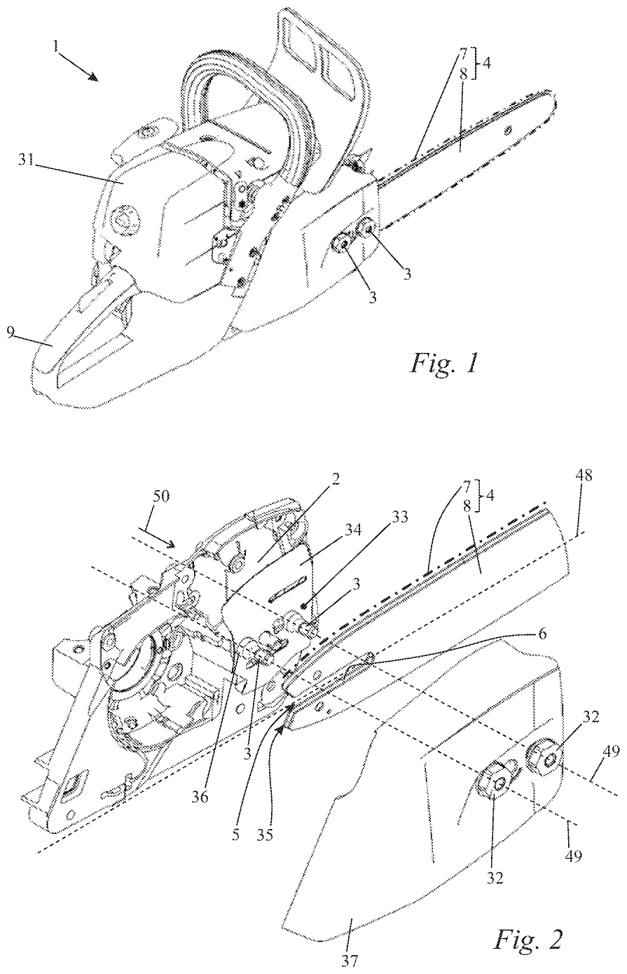

FIG. 1 shows a hand-guided work implement 1. The hand-guided work implement 1 is a motor chainsaw. The work implement 1 comprises a handle 9 and a guide bar 8 about which a saw chain 7 is guided circumferentially. The handle 9 is provided at a rear of a housing 31 of the motor chainsaw. The guide bar 8 projects at a front side of the housing 31 of the motor chainsaw away from the housing 31. The guide bar 8 and the saw chain 7 together form a tool 4 of the work implement 1. The tool 4 comprises an opening 5 illustrated in FIG. 2. The opening 5 is formed in the guide bar 8. At least one stud bolt 3 projects through the opening 5. A fastening element 32 screwed onto the stud bolt 3 clamps the guide bar 8 against the housing 31. The fastening element 32 is a nut in the embodiment.

As illustrated in FIG. 2, the work implement 1 comprises a housing part 2 that forms a part of the housing 31. A motor, not illustrated, for driving the saw chain 7 is secured at the housing part 2. In the embodiment, the housing part 2 is a part of a motor housing at which the motor is arranged. The motor is advantageously an internal combustion engine and the housing part 2 forms a part of a crankcase of the internal combustion engine. The at least one stud bolt 3 projects from the housing part 2. In the embodiment, two stud bolts 3 are provided. The stud bolts 3 extend along a longitudinal axis 49. The longitudinal axis 49 extends in axial direction 50. The axial direction 50 extends from the housing part 2 in the direction toward the guide bar 8. A stud bolt 3 is oriented perpendicularly to a contact surface 33 of the housing part 2; this is illustrated in FIG. 4. The guide bar 8 is directly or indirectly resting against the contact surface 33. Usually, a lateral plate 34 is placed onto the contact surface 33. The lateral plate 34 is then arranged between the guide bar 8 and the contact surface 33. The guide bar 8 is then placed onto the lateral plate 34. The lateral plate 34 comprises an opening with which it is pushed onto the stud bolt 3.

The stud bolt 3 is comprised of steel. In the embodiment, the stud bolt 3 is comprised of hardened steel. The housing part 2 is comprised advantageously at least partially of light metal, in particular of a magnesium alloy. It can also be provided that the housing part is comprised of a plurality of different materials.

In particular, the housing part 2 can form a part of a crankcase of an internal combustion engine of the work implement 1.

The stud bolt 3 is exchangeable. For this purpose, the stud bolt 3 can be unscrewed from the housing part 2, in particular from the side of the contact surface 33.

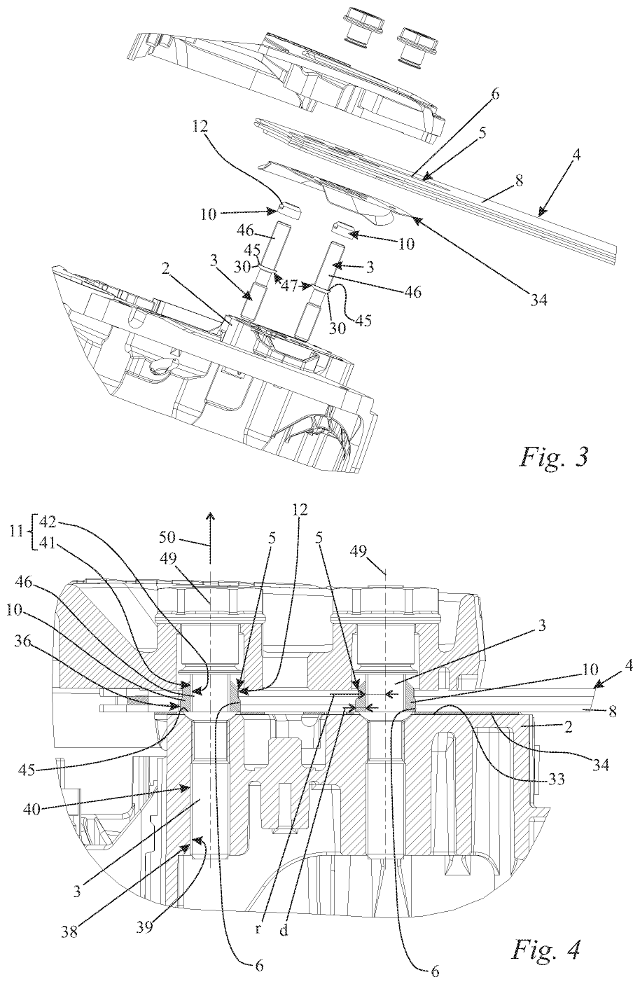

The guide bar 8 comprises a rearward end 35. The rearward end 35 comprises the opening 5. The rearward end 35 is facing the handle 9. The tool 4 extends along a longitudinal center axis 48. The longitudinal center axis 48 is the longitudinal center axis of the guide bar 8. The longitudinal center axis 48 extends perpendicularly to the longitudinal axis 49 of the stud bolt 3. The guide bar 8 extends in a plane that is perpendicular to the longitudinal axis 49. In the schematic illustration according to FIG. 2, the opening 5 of the guide bar 8 is open toward the rearward end 35 of the guide bar 8. However, it can also be provided that the opening 5 is closed in relation to the rearward end 35 of the guide bar 8. This is the case in the embodiments according to FIGS. 3 to 9 in which the opening 5 is embodied as a slotted hole. As illustrated in FIG. 2, the opening 5 penetrates the guide bar 8 in axial direction 50 completely. The opening 5 of the guide bar 8 is advantageously symmetrical in relation to a plane which is defined by the longitudinal center axis 48 and the longitudinal axis 49. The opening 5 extends along the longitudinal center axis 48.

For attaching the guide bar 8 to the housing part 2, the guide bar 8 with its opening 5 is pushed onto the two stud bolts 3. In the embodiments, the two stud bolts 3 are arranged one behind the other along the longitudinal center axis 48. The two stud bolts 3, considered individually, can be embodied identically. This applies to all embodiments. However, it can also be provided that the stud bolts 3 are differently designed.

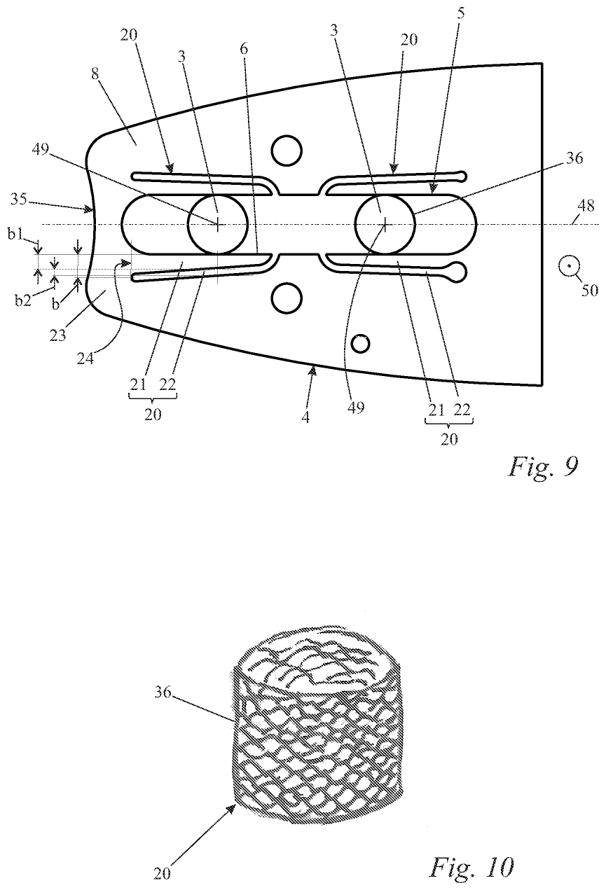

At the stud bolt 3, a collar 36 for supporting the guide bar 8 is arranged (see FIG. 2). The collar 36, as illustrated in FIGS. 3 to 7, can be formed by a separate component. However, it can also be provided that the collar 36 is an integral component of the stud bolt 3, as in the embodiments illustrated in FIGS. 8 and 9. In the embodiment according to FIG. 10, the collar 36 is also formed by a separate component. In the embodiments according to FIGS. 3 to 7, the collar 36 is part of the first element 10. In the embodiments according to FIGS. 3 to 7, the first element 10 is the separate component by means of which the collar 36 is formed. In the embodiment according to FIG. 10, the collar 36 is part of the second element 20. In the embodiment according to FIG. 10, the second element 20 is the separate component by means of which the collar 36 is formed. The guide bar 8 is resting with the circumference of its opening 5 at least indirectly at the collar 36. In the embodiments according to FIGS. 3 to 7 and 9 and 10, the guide bar 8 is resting with the circumference of its opening 5 directly at the collar 36. In the embodiment according to FIG. 8, the guide bar 8 is resting with its opening 5 indirectly by means of the first element 10 at the collar 36.

During mounting, the guide bar 8 is slidable in the direction of its longitudinal center axis 48 relative to the housing part 2 when contacting the stud bolts 3. When the guide bar 8 is in the desired position, the stud bolts 3 are guided through holes in a sprocket cover 37 of the work implement 1. The sprocket cover 37 covers the opening 5 of the guide bar 8 at least partially. The guide bar 8 is arranged between the housing part 2 and the sprocket cover 37. By movement of the guide bar 8 relative to the housing part 2, the saw chain 7 can be tensioned. Nuts as fastening means 32 are screwed onto the portion of the stud bolts 3 projecting from the sprocket cover 37. The nuts force the sprocket cover 37 and the guide bar 8 against the housing part 2. In this way, the guide bar 8 is fastened at the housing part 2. In operation of the work implement 1, at least one part of the tool 4 is immobile relative to the housing part 2. The saw chain 7 circulates about the guide bar 8 in operation of the work implement 1. The saw chain 7 is guided by the guide bar 8. In operation of the work implement 1, the guide bar 8 is immobile relative to the housing part 2.

The tool 4 has no rotational symmetry in relation to the longitudinal axis 49 of the stud bolt 3. The largest distance of an outer edge of the tool 4 in relation to the longitudinal axis 49 amounts to a multiple of the smallest distance of an outer edge of the tool 4 in relation to the longitudinal axis 49. In particular, the largest distance of an outer edge of the tool 4 to the longitudinal axis 49 amounts to at least twice the smallest distance of an outer edge of the tool 4 to the longitudinal axis 49.

In operation of the work implement 1, vibrations of the guide bar 8 may occur. Due to the vibrations but also during sawing with the motor chainsaw, forces are transmitted from the guide bar 8 to the stud bolt 3 and from the stud bolt 3 the force are introduced into the housing part 2. In order to keep the load of the housing part 2 as low as possible or even completely prevent load acting thereon, the work implement 1 comprises a transmission element. The transmission element serves for transmission of transverse forces, acting transversely to the axial direction 50, from the tool 4, in particular from the guide bar 8, to the stud bolt 3.

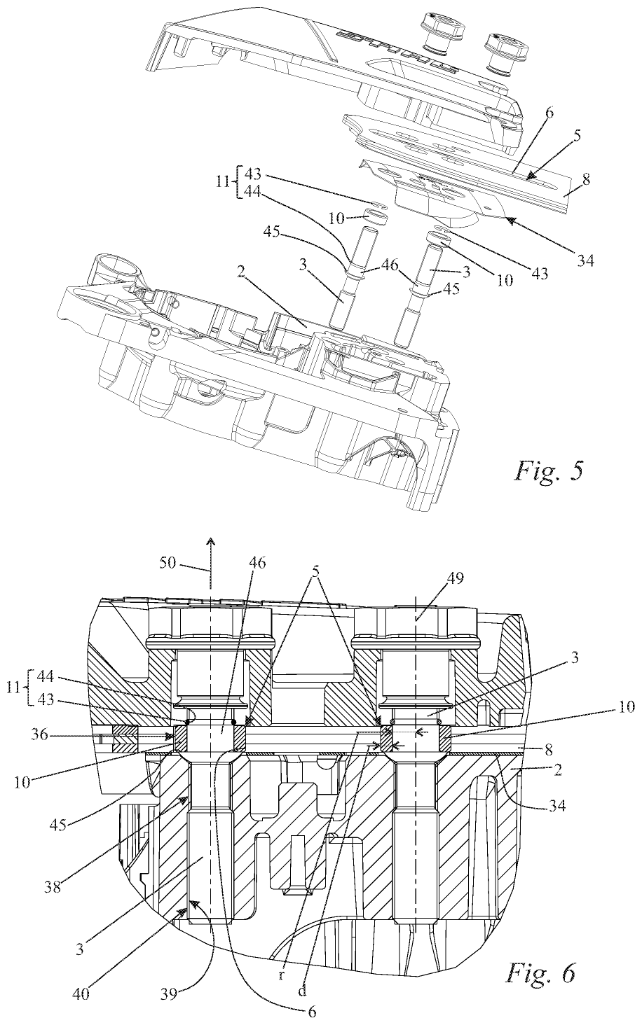

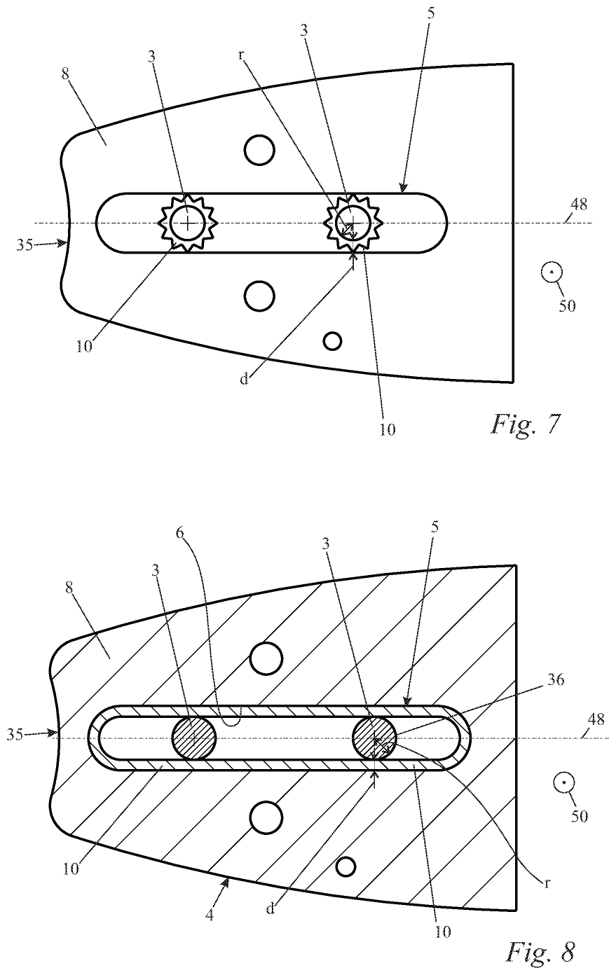

FIGS. 3 to 9 show various embodiments of a transmission element. Same or similar parts are identified with identical reference characters. In the embodiment according to FIGS. 3 and 4, the transmission element is a first element 10. The embodiment according to FIGS. 5 and 6 shows the first element 10 in an alternative configuration. FIGS. 7 and 8 each show a further embodiment of a first element 10. In FIG. 9, the transmission element is embodied as a second element 20.

The first element 10 is comprised at least partially of a first material that comprises a modulus of elasticity of 1 GPa to 80 GPa. The second element 20 comprises a spring element 21 and a free space 22 (FIG. 9). The spring element 21 is comprised at least partially of a second material with a modulus of elasticity of larger than 80 GPa. The free space 22 serves as a space for the spring travel for the spring element 21. The second element 20 is designed such that, upon transmission of the transverse forces, it acts at least partially due to its shape in a springy fashion. The second element 20 is a shape spring. The second element 20, as illustrated in FIG. 9, is embodied integrally with the guide bar 8. The guide bar 8 forms at its contact point at the stud bolt 3 in this case a shape spring for transmission of transverse forces from the guide bar 8 to the stud bolt 3.

However, it can also be provided that the second element 20 is arranged as a separate component between the guide bar 8 and the stud bolt 3. The springy action of the second element 20 can then be realized, for example, in that the second element 20 at least partially is comprised of a wire mesh structure, not illustrated. The wire mesh structure can be comprised of steel, for example. In particular, the wire mesh structure can comprise substantially the form of a hollow cylinder. Between the wires of the wire mesh structure, free spaces are formed. A section of a wire forms the spring element.

It can also be provided that the transmission element comprises a spring element and a free space for the spring travel of the spring element and that the spring element is comprised at least partially of the first material with a module of elasticity of 1 GPa to 80 GPa, in particular of 60 GPa to 80 GPa. It can be provided that the transmission element is comprised partially of the first material with a modulus of elasticity of 1 GPa to 80 GPa, in particular of 60 GPa to 80 GPa, and also acts at least partially in a springy fashion due to its shape upon transmission of transverse forces.

The first element 10 which is illustrated in FIGS. 3 to 8 is arranged between the stud bolt 3 and the tool 4. The first element 10 is arranged between the guide rail 8 and the stud bolt 3. As illustrated in FIGS. 4 and 6, the housing part 2 comprises a receptacle 38. The receptacle 38 serves for receiving the stud bolt 3. The receptacle 38 comprises an inner thread 39. The stud bolt 3 comprises at its longitudinal end facing the housing part 2 an outer thread 40. The stud bolt 3 is screwed into the receptacle 38. The outer thread 40 extends only across a portion of the length extension of the receptacle 38 in axial direction 50. The stud bolt 3 projects from the receptacle 38 in axial direction 50.

The opening 5 comprises a rim 6. In the embodiments according to FIGS. 3 to 8, the rim 6 extends in closed configuration circumferentially around the axial direction 50. The first element 10 is arranged between the rim 6 of the opening 5 in the stud bolt 3. The first element 10 contacts the stud bolt 3. The first element 10 extends circumferentially about the stud bolt 3. The transmission element extends in relation to the axial direction 50 completely around stud bolt 3. The transmission element surrounds the longitudinal axes 49 of the stud bolt 3 all the way. This applies to the first element 10 as well as to the second element 20 in the form of a wire mesh structure. The transmission element is arranged between the opening 5 and the stud bolt 3. This applies to the first element 10 according to FIGS. 3 to 8 as well as to the second element 20 in the form of a wire mesh structure. It can be provided that the transmission element is arranged with clearance on the stud bolt 3. This facilitates mounting and demounting.

In the embodiments according to FIGS. 3 to 7, the transmission element is a sleeve. The second element 20 of wire mesh structure can also be referred to as sleeve. The sleeve comprises substantially the shape of a hollow cylinder. It can also be provided that the sleeve is slotted. A slotted sleeve also comprises substantially the shape of a hollow cylinder. A common transmission element can be provided for the two neighboring stud bolts 3. The common transmission element comprises then two sleeves that are connected to each other. The two sleeves can be connected by a stay with each other. In a view in axial direction 50, this common transmission element is shaped like spectacles.

The stud bolt 3 comprises an element stop 45 in all embodiments. The element stop 45 serves as a stop for the transmission element in the direction opposite to the axial direction 50. The transmission element contacts the element stop 45. In the embodiments according to FIGS. 3 to 7, the element stop 45 secures the first element 10 against a movement opposite to the axial direction 50 in the direction toward the housing part 2. This applies also to the second element 20 that is designed as a wire mesh structure.

The element stop 45 extends in relation to the axial direction 50 advantageously completely circumferentially around the stud bolt 3. The element stop 45 is formed by a projection 47 of the stud bolt 3. The projection 47 projects past a bolt base body 46 in radial direction in relation to the longitudinal axis 49 of the stud bolt 3. The element stop 45 projects past the bolt base body 46 in radial direction in relation to the longitudinal axis 49 of the stud bolt 3. The projection 47 forms on its side which is facing the housing part 2 a bolt stop 30 for the stud bolt 3 at the housing part 2. In this way, the screw-in depth of the stud bolt 3 into the housing part 2 is limited. The projection 47 serves for contacting the housing part 2. By means of the projection 47, transverse forces from the stud bolt 3 can be transmitted to the housing part 2 in operation of the work implement 1.

The first element 10 according to the embodiment of FIGS. 3 to 7 is secured by a securing device 11 at the stud bolt 3. In the embodiments according to FIGS. 3, 4, and 7, the securing device 11 comprises a thread connection between the first element 10 and the stud bolt 3. The first element 10 is screwed onto the stud bolt 3. For this purpose, the stud bolt 3 comprises at its longitudinal end projecting from the housing part 2 an outer securing thread 41 (FIG. 4). The first element comprises an inner securing thread 42. The inner securing thread 42 corresponds with the outer securing thread 41. The outer securing thread 41 and the inner securing thread 42 form together the securing device 11 for securing the first element 10 on the stud bolt 3. Due to the securing device 11, the first element in operation is secured against a movement in axial direction 50 on the stud bolt 3. It can be provided in this context that the outer securing thread 41 comprises a distance from the element stop 45 that is measured in axial direction 50. The distance is larger than a height of the first element 10 measured in axial direction 50. Since the outer securing thread 41 extends only about a portion of the free end of the stud bolt 3, the first element 10 can be screwed on until the outer securing thread 41 and the inner securing thread 42 are disengaged. Due to the described distance, the first element 10 then is immediately positioned at the element stop 45. A movement against the axial direction 50 is only possible when the first element 10 is again engaged manually with its inner securing thread 42 in the outer securing thread 41 of the stud bolt 3. In addition, the first element 10 and the stud bolt 3 must be rotated in reverse rotational direction relative to each other.

The first element 10 comprises two flat surfaces 12. An open-end wrench can engage the two flat surfaces 12, and the first element 10 can be screwed in this way onto the stud bolt 3 or unscrewed from the stud bolt 3.

In the embodiment according to FIGS. 5 and 6, the securing device 11 is formed by a securing ring 43 and a groove 44 in the stud bolt 3. The groove 44 extends circumferentially about the stud bolt 3 in relation to the axial direction 50. The groove 44 is a recess in the outer surface of the stud bolt 3. The groove 44 is a recess in the bolt base body 46 of the stud bolt 3. In relation to the axial direction 50, the groove 44 is arranged at the end of the transmission element facing away from the housing part 2. The first element 10 is arranged between the groove 44 and the housing part 2. The securing ring 43 engages the groove 44. The securing ring 43 projects from the groove 44 in the direction transverse to the axial direction 50. The securing ring 43 delimits a movement of the transmission element, in particular of the first element 10, in axial direction 50. In this way, the transmission element, in particular the first element 10, is secured against a movement in the axial direction 50 relative to the stud bolt 3 in a direction away from the housing part 2. It can also be provided to secure the second element 20 that is in the form of a wire mesh structure by a securing device 11 with a securing ring 43 and a groove 44.

In the embodiment according to FIGS. 5 and 6, a locking element can be provided instead of the securing ring 43. The locking element is an integral component of the first element 10. The locking element, together with the groove 44, forms the securing device 11. When mounting the first element 10, the locking element snaps into the groove 44 and secures in this way the first element 10 permanently against a movement in axial direction 50 relative to the stud bolt 3.

In the embodiments according to FIGS. 3 to 7, the position of the first element 10 in relation to the axial direction 50 relative to the stud bolt 3 is limited to a defined region in relation to the longitudinal axis 49 of the stud bolt 3 by the interaction between the stop 45 and the securing device 11. The position of the first element 10 is determined such that the first element 10 extends at least across the entire width of the guide bar 8, measured in axial direction 50. It can also be provided to limit and to determine in an analog manner the position of the second element 20 in the form of a wire mesh structure.

The transmission element is exchangeably held at the stud bolt 3. This applies to the first element 10 according to the embodiments of FIGS. 3 to 7 as well as to the second element 20 that is embodied as a wire mesh structure.

In the embodiments according to FIGS. 3 to 7, the first element 10 is contacting with its inner side at least partially the stud bolt 3. Advantageously, a minimal clearance is provided between the first element 10 and the stud bolt 3. The first element 10 is contacting the stud bolt 3 in the direction transverse to the axial direction 50, in particular perpendicularly to the axial direction 50. The first element 10 is contacting the rim 6 of the opening 5 in the direction transverse to the axial direction 50, in particular in the direction perpendicular to axial direction 50. From the rim 6 of the opening 5, by means of the first element 10, transverse forces can be transmitted from the tool 4, in particular from the guide bar 8, to the first element 10. From the first element 10, transverse forces can be transmitted to the stud bolt 3. The stud bolt 3 comprises a modulus of elasticity of 190 GPa to 230 GPa, in particular of 210 GPa. The first element 10 is comprised at least partially of the first material that comprises a modulus of elasticity of 1 GPa to 80 GPa. In the embodiments according to FIGS. 3 to 8, the first element 10 consists completely of the first material. Due to the different moduli of elasticity of the first element 10 and of the stud bolt 3, a large difference between the stiffness of the first element 10 and the stiffness of the stud bolt 3 is provided. With regard to the stiffness, a jump in stiffness is provided in the direction radial to the longitudinal axis 49 of the stud bolt 3 at the transition from the transmission element to the stud bolt 3. In this way, the stiffness of the component group comprised of the stud bolt 3 and of the first element 10 changes in comparison to the stiffness of the stud bolt alone. The same applies to the second element 20 in the form of a wire mesh structure. Forces, in particular transverse forces, are transmitted through the first element 10 in a dampened manner from the guide bar 8 to the stud bolt 3. In this way, the forces acting on the connection between stud bolt 3 and housing part 2 are reduced. The wear of this connection, in particular of the inner thread 39 of the receptacle 38 for the stud bolt 3, is minimized.

In the embodiments, according to FIGS. 3 to 8, the first material of the first element 10 comprises a modulus of elasticity of 1 GPa to 80 GPa. The first material of the first element 10 in these embodiment can be plastic material or metal, in particular light metal. The light metal contains preferably aluminum. Advantageously, the light metal contains an aluminum alloy.

When the first material of the first element 10 is plastic material, the plastic material advantageously comprises a modulus of elasticity of 1 GPa to 10 GPa. The first material of the first element 10 is no elastomer. The plastic material of which the first material of the first element 10 is comprised is advantageously polyether ether ketone (PEEK). It can also be provided that the first element 10 of the embodiment according to FIGS. 3 to 8 comprises a modulus of elasticity of 1 GPa to 10 GPa and/or is comprised of plastic material, in particular of PEEK.

When the first material of the first element 10 is metal, the first material of the first element 10 comprises a modulus of elasticity of 10 GPa to 80 GPa, in particular of 50 GPa to 80 GPa. The first material of the first element 10 can be in particular light metal. Advantageously, the metal contains aluminum. Preferably, the metal comprises an aluminum alloy. The first element 10 can consist completely of the first material. It can also be provided that the first element 10 of the embodiment according to FIGS. 3 to 8 comprises a modulus of elasticity of 10 GPa to 80 GPa, in particular of 50 GPa to 80 GPa, and/or is comprised of light metal, in particular of an aluminum alloy.

The embodiments show a work implement 1 comprising the tool 4, the housing part 2, and the stud bolt 3 screwed into the housing part 2 for attachment of the tool 4 at the housing part 2, wherein the stud bolt 3 projects from the housing part 2 along the axial direction 50, wherein the tool 4 comprises the opening 5, wherein the stud bolt 3 projects at least partially into the opening 5, wherein the work implement 1, for transmission of transverse forces acting transversely to the axial direction 50 from the tool 4 to the stud bolt 3, comprises the transmission element, wherein the transmission element is selected from a group of a transmission element embodied as first element 10 and of a transmission element embodied as second element 20, wherein the first element 10 at least partially is comprised of a first material that comprises a modulus of elasticity of 1 GPa to 80 GPa and wherein the second element 20 comprises a spring element 21 of at least partially a second material with a modulus of elasticity of larger than 80 GPa and further comprises a free space 22 for a spring travel of the spring element 21.

In the embodiments according to FIGS. 3 to 9, the stud bolt 3 comprises in the region of the transmission element a stud bolt radius r. In the embodiments according to FIGS. 3 to 9, the stud bolt radius r amounts to more than 2.5 mm, in particular more than 2.8 mm, preferably more than 3.1 mm. The stud bolt radius r amounts to less than 4 mm, in particular less than 3.7 mm, preferably less than 3.3 mm.

The first element 10 comprises a maximum thickness d measured radially in relation to the longitudinal axis 49 of the stud bolt 3. It can also be provided that the maximum thickness d is measured radially in relation to the longitudinal axis 49 of the stud bolt 3 and perpendicularly to the longitudinal center axis 48. This is the case in the embodiments according to FIGS. 7 and 8. The maximum thickness d amounts to at least 30%, in particular at least 40%, preferably at least 50%, of the stud bolt radius r of the stud bolt 3. In the embodiments according to FIGS. 3 to 8, the maximum thickness d amounts to at least 1 mm, preferably at least 1.5 mm. The maximum thickness d amounts to at most 100%, in particular at most 80%, preferably at most 60%, of the stud bolt radius r. In the embodiments according to FIGS. 3 to 7, the maximum thickness d amounts to at most 3 mm, in particular at most 2.5 mm, preferably at most 2 mm. The aforementioned values apply also to the second element 20 in the form of a wire mesh structure.

In the embodiment according to FIG. 7, the first element 10 is embodied as a sleeve. The first element 10 comprises a star-shaped outer contour, viewed in plan view opposite to the axial direction 50. The first element 10 in the embodiment according to FIG. 7 is screwed onto the stud bolt 3. The thread connection between the stud bolt 3 and the first element 10 forms the securing device 11. The first element 10 in the embodiment according to FIG. 7 can however also be secured against a movement in axial direction 50 by any other of the securing devices 11 described in connection with FIGS. 3 to 6.

In the embodiment according to FIG. 8, the transmission element embodied as a first element 10 is secured at the tool 4. The first element 10 and the tool 4 are separate components. The first element 10 is secured at the rim 6 of the opening 5 of the tool 4. The first element 10 is non-slidable in relation to the tool 4 at least in the direction of the longitudinal center axis 48. The first element 10 is advantageously connected by being injection-molded onto the rim 6 of the opening 5. The first element 10 is therefore fixed in axial direction 50. The first element 10 can also be provided as an insertion part that is pressed into the opening 5 and also fixed in axial direction 50 in this way. The first element 10 extends in the embodiment according to FIG. 8 across the entire width of the guide bar 8 measured in axial direction 50. The first element 10 covers the rim 6 of the opening 5 completely. In the embodiment according to FIG. 8, the first element 10 extends in relation to the axial direction 50 completely circumferentially about the longitudinal axis 49 of the stud bolt 3.

In FIG. 9, the transmission element is designed as second element 20. The second element 20 is a component of the tool 4. The second element 20 is a component of the guide bar 8. In the guide bar 8, a slot is provided in the guide bar 8 that begins at the rim 6 of the opening 5. By means of the slot, a free space 22 is formed. Between the free space 22 and the opening 5 of the guide bar 8, a spring element 21 is formed. The spring element 21 is contacting the stud bolt 3. In the embodiment according to FIG. 9, the second element 20 is formed by the spring element 21 and the free space 22.

The free space 22 provides a space for a spring travel for the spring element 21. The second element 20 is designed such that, upon transmission of transverse forces, it is acting like a spring due to its shape.

The longitudinal center axis 48 of the tool 4 and the longitudinal axis 49 of the stud bolt 3 define a center plane. A maximal width b of the spring element 21 measured perpendicularly to the center plane is selected such that the spring element 21 acts like a spring.

In the embodiment according to FIG. 9, the free space 22 makes it possible that the spring element 21 can move in the direction transverse to the axial direction 50. In this way, forces, in particular transverse forces, are transmitted from the guide bar 8 to the stud bolt 3 in a springy fashion. The second element 20 is a shape spring.

The maximum width b of the spring element 21 is measured along an imaginary line on the guide bar 8. This imaginary line with the maximum width b of the spring element 21 marks a separation location between the second element 20 and a base body 23 of the guide bar 8. A plane perpendicular to the longitudinal center axis 48 separates the spring element 21 from the base body 23.

The second element 20 is arranged between the base body 23 and the stud bolt 3. In the embodiments according to FIGS. 3 to 8, the base body of the guide bars is formed by the entire guide bar 8. In this way, the first element 10 is also arranged between the base body of the guide bar 8 and the stud bolt 3 in the embodiments according to FIGS. 3 to 8. In all embodiments, the transmission element is arranged between the base body of the guide bar 8 and the stud bolt 3. This applies in relation to the direction transverse to, in particular perpendicular to, in particular radial to the axial direction 50.

The spring element 21 of the second element 20 is arranged between the free space 22 of the second element 20 and the stud bolt 3. The spring element 21 is a tongue. The tongue originates at the base body 23 of the guide bar 8. The tongue extends substantially along the direction of the longitudinal center axis 48 of the guide bar 8. The spring element 21 comprises a longitudinal end 24. At the longitudinal end 24, the spring element 21 has the maximum width b. The spring element 21 is secured with its longitudinal end 24 at the base body 23 of the guide bar 8. The spring element 21 is an integral component of the guide bar 8. The spring element 21 is monolithic with the base body 23.

The spring element 21 of the second element 20 comprises a spring width b1. The spring width b1 is measured radially in relation to the longitudinal axis 49 of the stud bolt 3 and perpendicularly to the longitudinal center axis 48 of the tool 4. The spring width b1 is measured perpendicularly to the center plane at the level of the longitudinal axis 49 of the stud bolt 3.

The free space 22 is arranged between the base body 23 and the spring element 21. The free space 22 is arranged in relation to the radial direction of the longitudinal axis 49 between the base body 23 and the spring element 21. The free space 22 of the second element 20 has a free space width b2. The free space width b2 is measured radially to the longitudinal axis 49 of the stud bolt 3 and perpendicularly to the longitudinal center axis 48 of the tool 4. The free space width b2 is measured perpendicularly to the center plane at the level of the longitudinal axis 49 of the stud bolt 3. The free space width b2 is measured between the spring element 21 and the base body 23. The free space width b2 is measured upon contact of the spring element 21 at the stud bolt 3. The free space width b2 amounts to at least 10%, in particular at least 20%, of the spring width b1. In the embodiment according to FIG. 9, the free space width b2 amounts to at least 30% of the spring width b1.

The free space width b2 amounts to at least 10%, in particular at least 20%, of the maximum width b. In the embodiment according to FIG. 9, the free space width b2 amounts to at least 0.1 mm, in particular at least 0.5 mm. The free space width b2 amounts to at most 70%, in particular at most 50%, particularly preferred at most 40%, of the maximum width b. The free space width b2 amounts to at most 2 mm, in particular at most 1.5 mm.

The second element 20 is comprised at least partially of a second material that comprises a modulus of elasticity of larger than 80 GPa. The spring element 21 is comprised at least partially of a second material that comprises a modulus of elasticity of larger than 80 GPa. It can also be provided that the second element 20, in particular the spring element 21, is comprised at least partially of a material that comprises a modulus of elasticity of larger than 60 GPa. In the embodiment according to FIG. 9, the spring element 21 comprises a modulus of elasticity of 200 GPa to 330 GPa, in particular of 280 GPa to 330 GPa, preferably of 290 GPa to 320 GPa. In the embodiment according to FIG. 9, the second material is steel. The spring element 21 consists completely of the second material. The base body 23 of the guide bar 8 is comprised of the second material. The guide bar 8 comprises a modulus of elasticity of larger than 80 GPa. The guide bar 8 comprises in the embodiments a modulus of elasticity of 200 GPa to 330 GPa, in particular of 280 GPa to 330 GPa. The guide bar 8 is comprised of steel.

In the embodiments according to FIGS. 8 and 9, the transmission element is fastened to the tool 4. The transmission element is captively held at the tool 4. The transmission element is non-detachably connected to the tool 4. In the embodiment according to FIG. 9, the transmission element is formed at the tool 4.

It can also be provided that the second element 20 is embodied as a wire mesh structure which comprises substantially the form of a hollow cylinder. FIG. 10 shows a second element 20 that is formed of wire mesh structure. Such a second element is also referred to as wire mesh structure. The wire mesh structure can be exchangeably pushed onto the stud bolt 3. The wire mesh structure is arranged between the guide bar 8 and the stud bolt 3. The wire mesh structure is comprised of a second material that comprises a modulus of elasticity of larger than 80 GPa, in particular of 200 GPa to 330 GPa, preferably of 280 GPa to 330 GPa. The wire mesh structure can be comprised of steel. A section of a wire forms a spring element. Due to the distance between two neighboring wires of the wire mesh structure, a free space is formed. The free space is arranged in relation to the radial direction of the longitudinal axis 49 of the stud bolt 3 between the spring element and the guide bar 8.

The specification incorporates by reference the entire disclosure of European priority document 20 183 204.5 having a filing date of Jun. 30, 2020.

While specific embodiments of the invention have been shown and described in detail to illustrate the inventive principles, it will be understood that the invention may be embodied otherwise without departing from such principles.

What is claimed is:

1. A work implement comprising:
a tool comprising an opening;
a housing part;
a stud bolt screwed into the housing part and configured to fasten the tool to the housing part, wherein the stud bolt projects away from the housing part along an axial direction, and wherein the stud bolt projects at least partially into the opening of the tool;
a transmission element configured to transmit transverse forces, acting transversely to the axial direction, from the tool to the stud bolt;
wherein the transmission element is a first element and wherein the first element is comprised at least partially of a first material comprising a modulus of elasticity of 1 GPa to 80 GPa; or
wherein the transmission element is a second element and wherein the second element comprises a spring element at least partially comprised of a second material comprising a modulus of elasticity of larger than 80 GPa and wherein the second element further comprises a free space for a spring travel of the spring element.

2. The work implement according to claim 1, wherein the transmission element extends completely circumferentially about the stud bolt in relation to the axial direction.

3. The work implement according to claim 1, wherein the transmission element is arranged between the opening of the tool and the stud bolt.

4. The work implement according to claim 1, wherein the transmission element is fastened to the tool.

5. The work implement according to claim 1, wherein the opening of the tool comprises a rim and wherein the transition element is secured at the rim of the opening of the tool.

6. The work implement according to claim 1, wherein the transmission element is fastened to the stud bolt.

7. The work implement according to claim 6, wherein the transmission element is captively secured at the stud bolt.

8. The work implement according to claim 1, wherein the transmission element is exchangeably held at the stud bolt.

9. The work implement according to claim 1, wherein the transmission element is a sleeve.

10. The work implement according to claim 9, wherein the sleeve comprises substantially a shape of a hollow cylinder.

11. The work implement according to claim 1, wherein the first element consists of the first material.

12. The work implement according to claim 1, wherein the first material is a plastic material.

13. The work implement according to claim 1, wherein the first material is no elastomer.

14. The work implement according to claim 1, wherein the first material is a light metal.

15. The work implement according to claim 1, wherein the spring element of the second element consists of the second material.

16. The work implement according to claim 1, wherein the spring element of the second element is arranged between the free space of the second element and the stud bolt.

17. The work implement according to claim 1, wherein the housing part is comprised at least partially of light metal.

18. The work implement according to claim 17, wherein the light metal is an aluminum alloy or a magnesium alloy.

19. The work implement according to claim 1, wherein the tool has no rotational symmetry in relation to a longitudinal axis of the stud bolt.
